(19) United States
(12) Patent Application Publication
(10) Pub. No.: US 2022/0408971 A1
(43) Pub. Date: Dec. 29, 2022

(54) GRILL BASKET

(71) Applicant: SHENZHEN WANQUAN BUSINESS INFORMATION TECHNOLOGY CO., LTD, Shenzhen (CN)

(72) Inventor: JINPING LENG, SHENZHEN (CN)

(21) Appl. No.: 17/381,319

(22) Filed: Jul. 21, 2021

(30) Foreign Application Priority Data
Jun. 29, 2021 (CN) 202121467019.9

(51) Int. Cl. A47J 37/07

(52) U.S. Cl. CPC A47J 37/0786; A47J 2037/0795

(57) ABSTRACT

A grill basket relating to the technical field of grill utensils is provided, comprising: a grill basket and a partition detachably or rotatably assembled in the grill basket; wherein the partition is configured to divide an entire grill space in the grill basket into at least two grill spaces. The above technical solution has the advantage that the entire grill space can be used for grilling food, or the entire grill space can be divided into multiple grill spaces to grill food.

### FIELD OF THE DISCLOSURE

The present disclosure relates to the technical field of grill utensils, in particular, to a grill basket.

### BACKGROUND OF THE DISCLOSURE

The existing grill basket has an integral grill space. When it is desired to grill foods that are not mixed together, it can only be grilled several times, which is very troublesome, so it is in urgent need of improvement.

### SUMMARY OF THE DISCLOSURE

The purpose of the present disclosure is to provide a grill basket in view of the defects and deficiencies of the prior art, which has the advantage that the entire grill space can be used to grill food, and the entire grill space can be divided into multiple grill spaces to grill food.

In order to achieve the above objective, the technical solution adopted by the present disclosure is: a grill basket, comprising: a grill basket and a partition detachably or rotatably assembled in the grill basket; wherein the partition is configured to divide an entire grill space in the grill basket into at least two grill spaces.

In a preferred embodiment of the present disclosure, when the partition is detachably assembled in the grill basket, the partition comprises: a first partition for separating the grill space, and a first assembly part formed on the first partition and detachably assembled on the grill basket.

In a preferred embodiment of the present disclosure, an assembly end of the first assembly part is provided with a C-shaped hook or a J-shaped hook.

In a preferred embodiment of the present disclosure, the first partition has a strip shape or an H shape.

In a preferred embodiment of the present disclosure, the first partition has a strip hollow shape.

In a preferred embodiment of the present disclosure, when the partition is rotatably assembled in the grill basket, the partition comprises: a second partition for separating the grill space, and a second assembly part formed on the second partition and rotatably assembled in the grill basket.

In a preferred embodiment of the present disclosure, the second assembly part is a rotating shaft hinged in the grill basket.

In a preferred embodiment of the present disclosure, the second partition has a strip hollow shape.

In a preferred embodiment of the present disclosure, the grill basket and the partition are made of 304 stainless steel.

In a preferred embodiment of the present disclosure, the grill basket comprises a grill basket body, a cover detachably or rotatably assembled on the grill basket body and configured to cover an upper end of the grill basket body, and a handle assembled on the grill basket body.

After adopting the above technical solution, the present disclosure has the following beneficial effects. In the present disclosure, by providing a detachable or rotating partition that is assembled in the grill basket, when the partition is removed or transferred to the bottom surface of the grill basket, the entire grill space is used for grilling food; after the partition is assembled or turned upright, multiple grill spaces can be used to grill food.

### BRIEF DESCRIPTION OF THE DRAWINGS

In order to explain the embodiments of the present disclosure or the technical solutions in the prior art more clearly, the following will briefly introduce the drawings that need to be used in the description of the embodiments or the prior art. Obviously, the drawings in the following description are only some embodiments of the present disclosure. For those of ordinary skill in the art, other drawings can be obtained based on these drawings without creative labor.

FIG. 1 is a schematic structural diagram according to the first embodiment.

FIG. 2 is a schematic structural diagram illustrating the partition during assembly according to the first embodiment.

FIG. 3 is a schematic structural diagram illustrating the partition during disassembly according to the first embodiment.

FIG. 4 is a schematic structural diagram illustrating the partition during assembly according to the second embodiment.

FIG. 5 is a schematic structural diagram illustrating the partition during disassembly according to the second embodiment.

FIG. 6 is an enlarged schematic diagram of A in FIG. 5.

FIG. 7 is a schematic structural diagram illustrating when the partition is erected according to the third embodiment.

FIG. 8 is an enlarged schematic diagram of B in FIG. 7.

FIG. 9 is a schematic structural diagram illustrating when the partition is stored on the bottom surface according to the third embodiment.

Reference numeral: 1. grill basket; 11. grill basket body; 12. cover; 13, handle; 2. partition; 21. first partition; 22. first assembly part; 23. second partition; 24. second assembly part.

### DETAILED DESCRIPTION OF THE EXEMPLARY EMBODIMENTS

Hereinafter, the present disclosure will be further described in detail with reference to the accompanying drawings.

This specific embodiment is only an explanation of the present disclosure, and it is not a limitation of the present disclosure. After reading this specification, those skilled in the art can make modifications to this embodiment that do not create any contribution as needed, but as long as it is within the scope of the claims of the present disclosure, it is protected by the patent law.

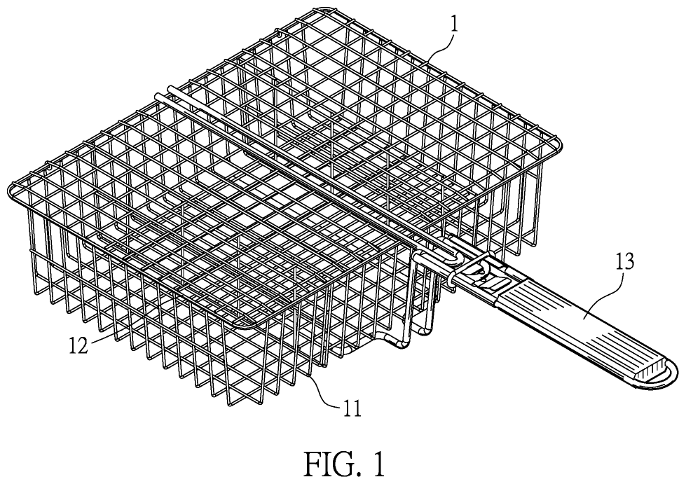

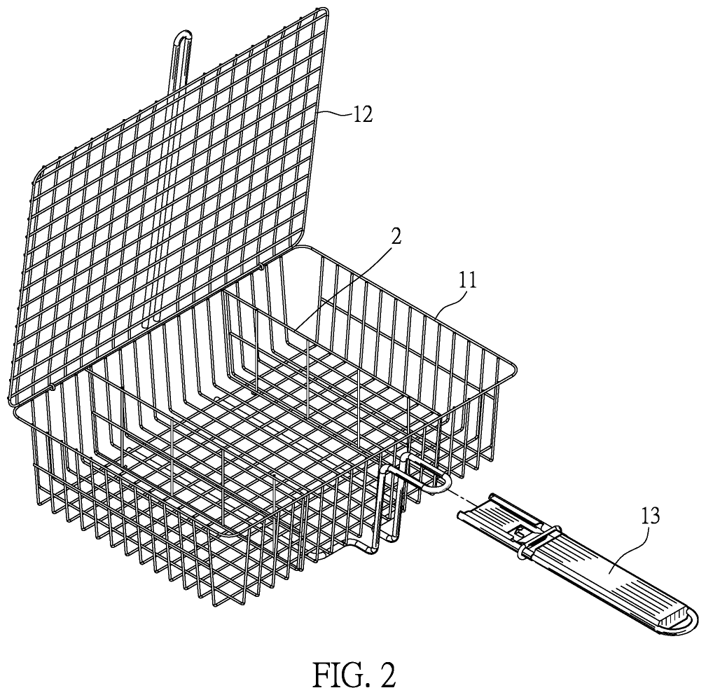

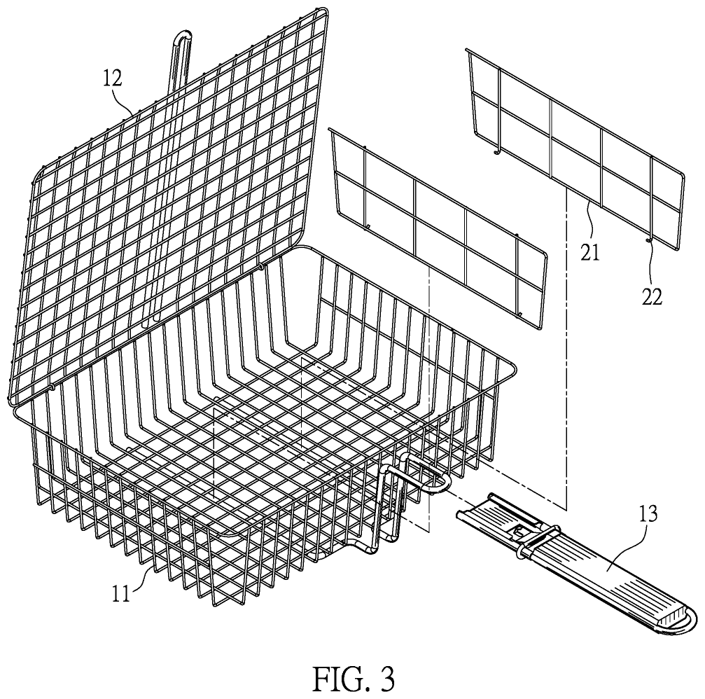

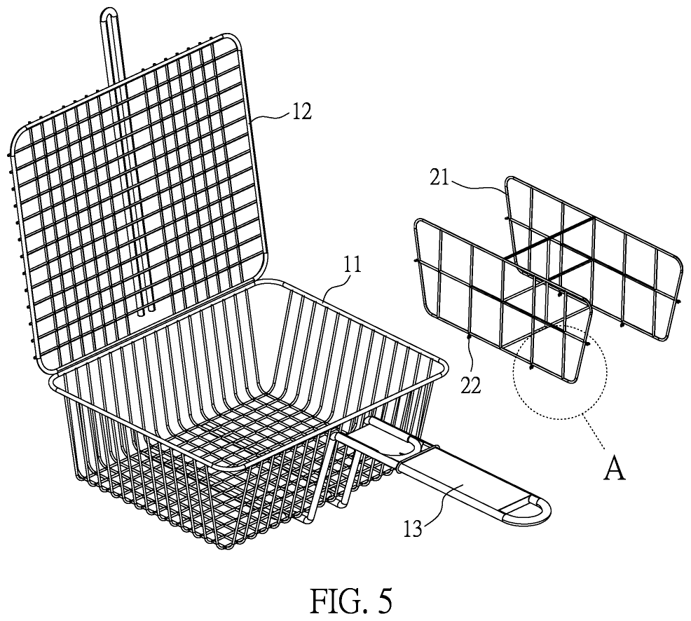

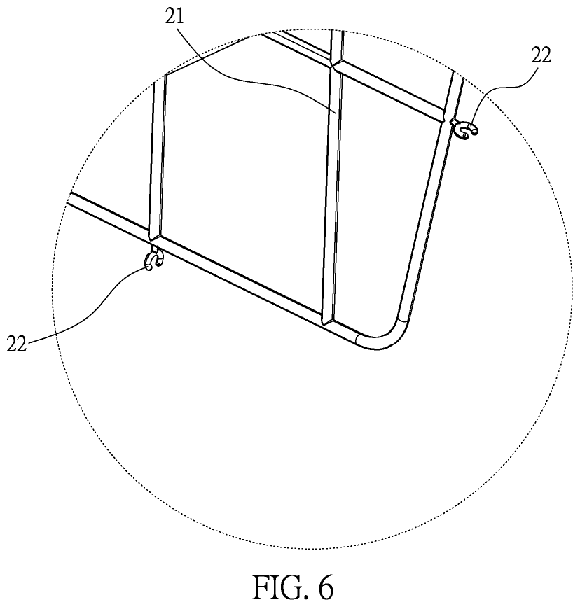

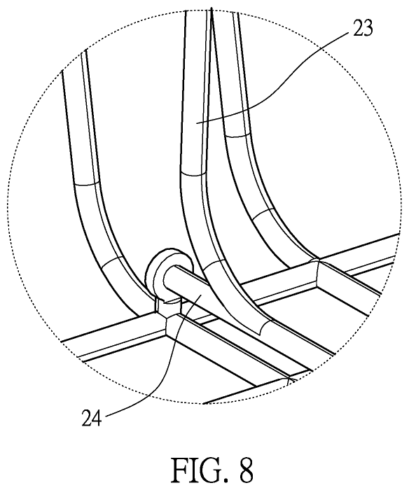

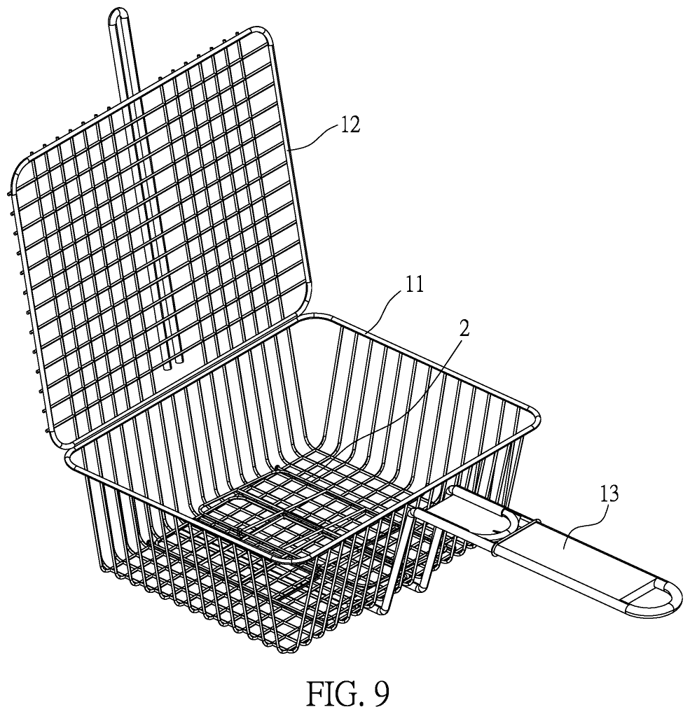

The present disclosure relates to a grill basket, as shown in FIGS. 1-9, comprising: a grill basket 1 and a partition 2 detachably or rotatably assembled in the grill basket 1. The partition 2 is configured to divide an entire grill space in the grill basket 1 into at least two grill spaces. By providing the partition 2, when the partition 2 is removed or turned to the bottom surface of the grill basket 1, the entire grill space can be used for grilling food. After the partition 2 is assembled or turned upright, multiple grill spaces can be used to grill food.

The grill basket 1 comprises a grill basket body 11, a cover 12 detachably or rotatably assembled on the grill basket body 11 and configured to cover an upper end of the grill basket body 11, and a handle 13 assembled on the grill basket body 11.

The partition 2 detachably or rotatably assembled in the grill basket 1 means: not only the partition 2 is detachably or rotatably assembled in the grill basket body 1, but also the partition 2 is detachably or rotatably assembled on the cover 12.

Embodiment 1: The partition 2 is detachably assembled in the grill basket 1. As shown in FIGS. 1 to 3, the partition 2 includes: a first partition 21 for separating the grill space, and a first assembly part 22 formed on the first partition 21 and detachably assembled on the grill basket 1. Specifically, the bottom end (assembly end) of the first assembly part 22 is provided with a J-shaped hook, which is hooked to the bottom side of the grill basket body 11. The first partition 21 has a strip-shaped hollow shape. In this embodiment, there are two partitions 2 and after the partitions 2 are assembled, the entire grill space is divided into three small spaces. Of course, in other embodiments, the shape and number of the partitions 2 can be modified adaptively.

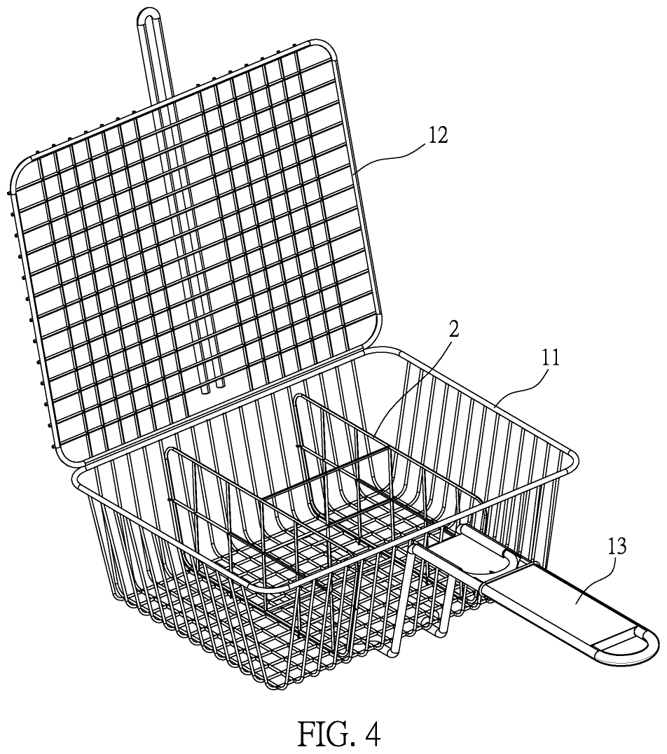

Embodiment 2: The partition 2 is detachably assembled in the grill basket 1. As shown in FIGS. 4-6, the partition 2 includes: a first partition 21 for separating the grill space, and a first assembly part 22 formed on the first partition 21 and detachably assembled on the grill basket 1. Specifically, the bottom end and both sides of the first assembly part 22 are provided with C-shaped hooks, which are hooked on the bottom and two sides of the body of the grill basket body 11. The first partition 21 has an H-shaped hollow shape. In this embodiment, there is one partition 2 and after the partition 2 is assembled, the entire grill space is divided into four small spaces. Of course, in other embodiments, the shape and number of the partitions 2 can be modified adaptively.

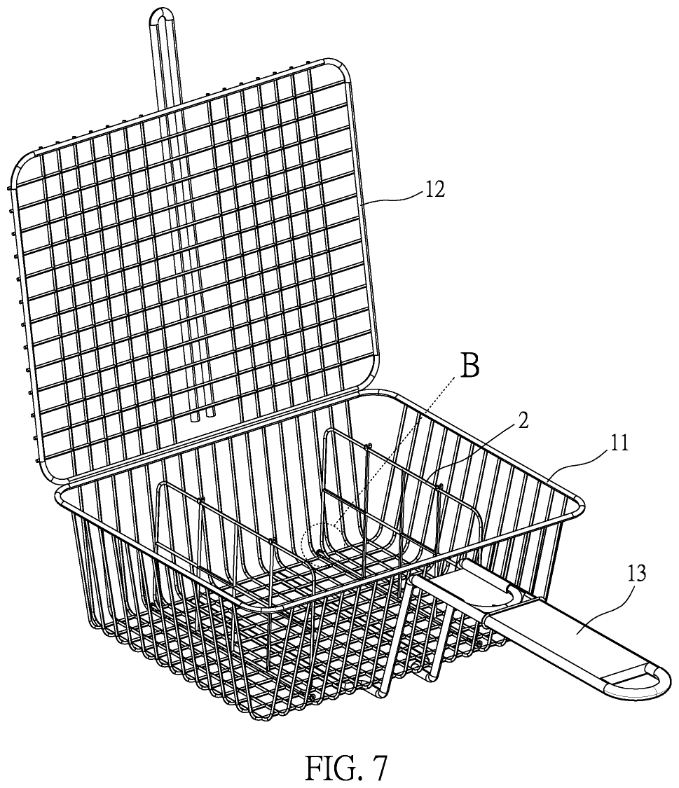

Embodiment 3: The partition 2 is rotatably assembled in the grill basket 1. As shown in FIGS. 7-9, the partition 2 includes: a second partition 23 for separating the grill space, and a second assembly part 24 formed on the second partition 23 and rotatably assembled in the grill basket 1. Specifically, the second assembly part 24 is a rotating shaft hinged to the bottom side of the grill basket body 11. The second partition 23 has a strip-shaped hollow shape. In this embodiment, there are two partitions 2, and after the partitions 2 are assembled, rotated and erected, the entire grill space is divided into three small spaces. Of course, in other embodiments, the shape and number of the partitions 2 can be modified adaptively.

In the above three embodiments, the grill basket 1 and the partition 2 are made of 304 stainless steel. However, in other embodiments, other materials can also be used.

In the above three embodiments, the partition 2 is assembled on the grill basket body 1, but in other embodiments, the partition 2 can also be assembled on the cover12.

The working principle of the present disclosure is roughly as follows. The grill basket 1 is used for grilling food. When larger foods need to be grilled or the foods can be mixed, the partition 2 is removed or rotated and placed at the bottom to keep the grill basket 1 as an entire large space. When the grilled food is to be separated, the partition 2 is assembled or turned upright, so that there are multiple grill spaces in the grill basket 1 to grill the food.

The above are only used to illustrate the technical solutions of the present disclosure and not to limit them. Other modifications or equivalent substitutions made by those of ordinary skill in the art to the technical solutions of the present disclosure shall be covered, and as long as they do not depart from the spirit and scope of the technical solutions of the present disclosure, they shall be included within the scope of the claims of the present disclosure.

What is claimed is:

1. A grill basket, comprising: a grill basket (1) and a partition (2) detachably or rotatably assembled in the grill basket (1); wherein the partition (2) is configured to divide an entire grill space in the grill basket (1) into at least two grill spaces.

2. The grill basket according to claim 1, wherein when the partition (2) is detachably assembled in the grill basket (1), the partition (2) comprises:
a first partition (21) for separating the grill space; and
a first assembly part (22) formed on the first partition (21) and detachably assembled on the grill basket (1).

3. The grill basket according to claim 2, wherein an assembly end of the first assembly part (22) is provided with a C-shaped hook or a J-shaped hook.

4. The grill basket according to claim 2, wherein the first partition (21) has a strip shape or an H shape.

5. The grill basket according to claim 2, wherein the first partition (21) has a hollow shape.

6. The grill basket according to claim 1, wherein when the partition (2) is rotatably assembled in the grill basket (1), the partition (2) comprises:
a second partition (23) for separating the grill space, and a second assembly part (24) formed on the second partition (23) and rotatably assembled in the grill basket (1).

7. The grill basket according to claim 6, wherein the second assembly part (24) is a rotating shaft hinged in the grill basket (1).

8. The grill basket according to claim 6, wherein the second partition (23) has a strip hollow shape.

9. The grill basket according to claim 1, wherein the grill basket (1) and the partition (2) are made of 304 stainless steel.

10. The grill basket according to claim 1, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

11. The grill basket according to claim 2, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

12. The grill basket according to claim 3, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

13. The grill basket according to claim 4, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

14. The grill basket according to claim 5, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

15. The grill basket according to claim 6, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

16. The grill basket according to claim 7, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

17. The grill basket according to claim 8, wherein the grill basket (1) comprises:
a grill basket body (11);
a cover (12) detachably or rotatably assembled on the grill basket body (11) and configured to cover an upper end of the grill basket body (11); and
a handle (13) assembled on the grill basket body (11).

18. The grill basket according to claim 9, wherein the grill basket (1) comprises: a grill basket body (11);
a cover (12) detachably or rotatably assembled on the grill basket body (11) and configured to cover an upper end of the grill basket body (11); and
a handle (13) assembled on the grill basket body (11).
